(19) United States
(12) Patent Application Publication
(10) Pub. No.: US 2012/0186961 A1
(43) Pub. Date: Jul. 26, 2012

(54) INFORMATION PROCESSING APPARATUS AND OPERATION INPUT DEVICE

(75) Inventors: Shin Oike, Nagano (JP); Junichi Tadano, Nagano (JP); Tomoaki Watanabe, Nagano (JP); Takayuki Hiraishi, Nagano (JP)

(73) Assignee: SONY CORPORATION, Tokyo (JP)

(21) Appl. No.: 13/345,876

(22) Filed: Jan. 9, 2012

(30) Foreign Application Priority Data
Jan. 21, 2011 (JP) P2011-011417

(51) Int. Cl. H01H 13/76

(52) U.S. Cl. 200/5 A

(57) ABSTRACT

An information processing apparatus includes a keyboard having a plurality of keys. The keyboard includes a sheet having a plurality of switch units for switching a non-conductive state and a conductive state according to operation with which the plurality of keys are respectively pressed down, the sheet having a first opening portion at a position corresponding to at least one of the keys, and a light emitting member provided below the sheet to emit light toward the key, the light emitting member having a second opening portion at a position corresponding to at least one of the keys.

### BACKGROUND

The present disclosure relates to an information processing apparatus and an operation input device.

In recent years, a keyboard is widely used as an input device to enter user's operation in electronic devices such as personal computers. For example, Japanese Patent Application Laid-Open No. 2006-99630 describes a technique for improving the cooling efficiency in a main body of an apparatus while ensuring preferable design.

### SUMMARY

However, in the technique described in Japanese Patent Application Laid-Open No. 2006-99630 above, intake holes are provided at a side of a keyboard to draw air, but there is only a limited space at the side of the keyboard, which limits the improvement of the cooling efficiency. In particular, in recent years, the downsizing has become prominent in electronic devices such as personal computers, and this results in lack of space for providing intake holes. Accordingly, further decrease of the cooling efficiency is anticipated.

In light of the foregoing, it is desirable to provide an information processing apparatus and an operation input device which are novel and improved and capable of greatly improving the cooling efficiency with a simple configuration.

According to an embodiment of the present invention, there is provided an information processing apparatus including a keyboard having a plurality of keys. The keyboard includes a sheet having a plurality of switch units for switching a non-conductive state and a conductive state according to operation with which the plurality of keys are respectively pressed down, the sheet having a first opening portion at a position corresponding to at least one of the keys, and a light emitting member provided below the sheet to emit light toward the key, the light emitting member having a second opening portion at a position corresponding to at least one of the keys.

In this configuration, the key is engraved with a character with a light transmitting unit transmitting the light emitted by the light emitting member, and the second opening portion is provided at a position not overlapping the character of the key.

In this configuration, the information processing apparatus further includes a plate provided between the sheet and the light emitting member to support the sheet and having a third opening portion at a position corresponding to the first opening portion.

In this configuration, the information processing apparatus further includes a cooling fan for discharging heat inside to outside, the second opening portion is provided in a region other than a portion immediately above the cooling fan.

According to another embodiment of the present invention, there is provided an operation input device includes a plurality of keys, a sheet having a plurality of switch units for switching a non-conductive state and a conductive state according to operation with which the plurality of keys are respectively pressed down, the sheet having a first opening portion at a position corresponding to at least one of the keys, and a light emitting member provided below the sheet to emit light toward the key, the light emitting member having a second opening portion at a position corresponding to at least one of the keys.

In this configuration, the key is engraved with a character with a light transmitting unit transmitting light emitted by the light emitting member, and the second opening portion is provided at a position not overlapping the character of the key.

In this configuration, the operation input device further includes a plate provided between the sheet and the light emitting member to support the sheet and having a third opening portion at a position corresponding to the first opening portion.

In this configuration, the operation input device further includes a cooling fan for discharging heat inside to outside, the second opening portion is provided in a region other than a portion immediately above the cooling fan.

According to an embodiment of the present disclosure, an information processing apparatus and an operation input device capable of greatly improving the cooling efficiency with a simple configuration can be provided.

### BRIEF DESCRIPTION OF THE DRAWINGS

FIG. 1 is a perspective view illustrating an external appearance of an information processing apparatus according to an embodiment of the present disclosure;

FIG. 2 is a exploded perspective view illustrating an apparatus main body;

FIG. 3 is a perspective view illustrating a keyboard;

FIG. 4 is a perspective view illustrating a lower shell to which a circuit substrate assembly is attached;

FIG. 5 is an exploded perspective view illustrating members constituting a keyboard;

FIG. 6 is a top view illustrating a configuration of a membrane sheet;

FIG. 7 is a top view illustrating a configuration of a plate;

FIG. 8 is a top view illustrating a configuration of a light emitting sheet;

FIG. 9 is a top view illustrating a switch unit of a membrane sheet corresponding to a key;

FIG. 10 is a top view illustrating a support unit of the plate corresponding to the key and a periphery thereof;

FIG. 11 is a top view illustrating a light emitting unit and an opening portion of a light emitting sheet corresponding to the key;

FIG. 12 is a top view illustrating the membrane sheet, the plate, and the light emitting sheet shown in FIGS. 9, 10, and 11 when the membrane sheet, the plate, and the light emitting sheet are overlaid;

FIG. 13 is a schematic view illustrating a cross section of the keys and the opening portions;

FIG. 14 is an enlarged schematic view illustrating a region A2 shown in FIG. 13, and shows how external air is drawn through the opening portions when a cooling fan is driven;

FIG. 15 is a schematic view illustrating a detailed cross sectional structure shown in FIG. 14, and shows both of the cooling fan and the circuit substrate.

FIG. 16 is a schematic view illustrating an example of positional relationship between the key and the opening portion; and

FIG. 17 is a schematic view illustrating a key with which more characters can be input and in which more light transmitting units are provided.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following explanation will be made in an order described below.

1. Example of external appearance of information processing apparatus

2. Example of configuration of information processing apparatus

3. Configuration of keyboard

4. Flow of air drawn through keyboard

5. Example of arrangement of opening portion in light emitting sheet

### [1. Example of External Appearance of Information Processing Apparatus]

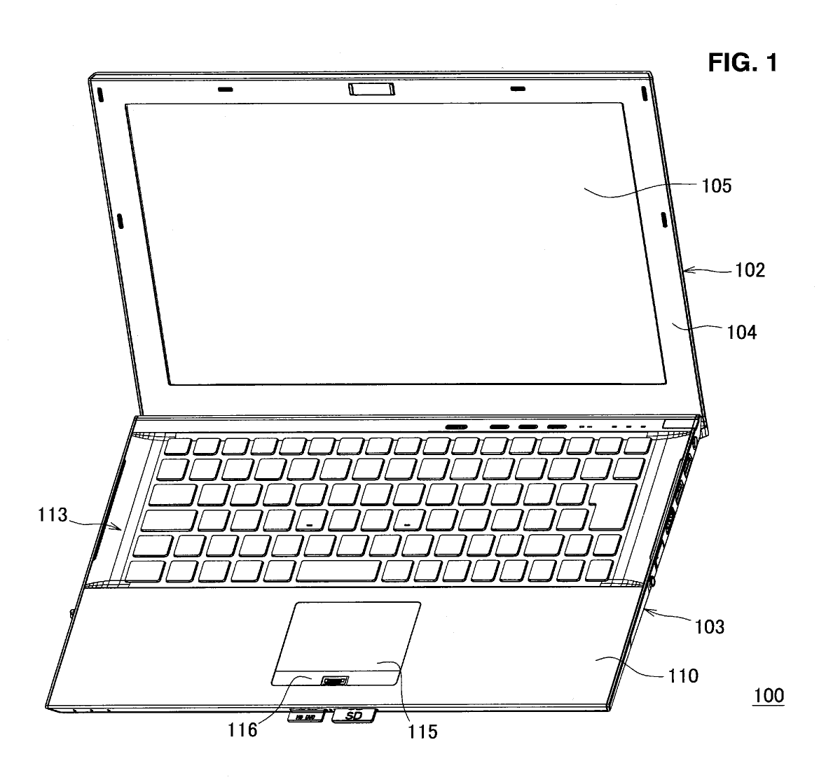

First, a schematic configuration of an information processing apparatus 100 according to a first embodiment of the present disclosure will be explained with reference to FIG. 1. FIG. 1 is a perspective view illustrating an external appearance of the information processing apparatus 100 according to the embodiment of the present disclosure. As shown in FIG. 1, in the present embodiment, a notebook-type personal computer will be shown as an example of the information processing apparatus 100. However, the information processing apparatus 100 is not limited to the personal computer. For example, the present embodiment can be applied to various kinds of information processing apparatuses such as a personal digital assistant (PDA), a network terminal, mobile devices such as a mobile phone, and a workstation.

As shown in FIG. 1, the information processing apparatus 100 includes a display unit 102 and an apparatus main body 103. The display unit 102 includes a display housing 104 and a display screen 105 provided on the display housing 104. A horizontally long keyboard 113 is provided on the upper surface of the apparatus main body 103. The display unit 102 is pivotably supported at the rear end portion of the apparatus main body 103 via a hinge unit on the apparatus main body 103. The display unit 102 can pivot between a closed position at which the display unit 102 closes the apparatus main body 103 and an open position at which the display unit 102 opens the apparatus main body 103. When the display unit 102 opens, the keyboard 113 provided on the apparatus main body 103 can be used. As shown in FIG. 1, a touch pad 115 and an operation key 116 are provided on the upper surface of the apparatus main body 103 at the front side position of the keyboard 113.

### [2. Example of Configuration of Information Processing Apparatus]

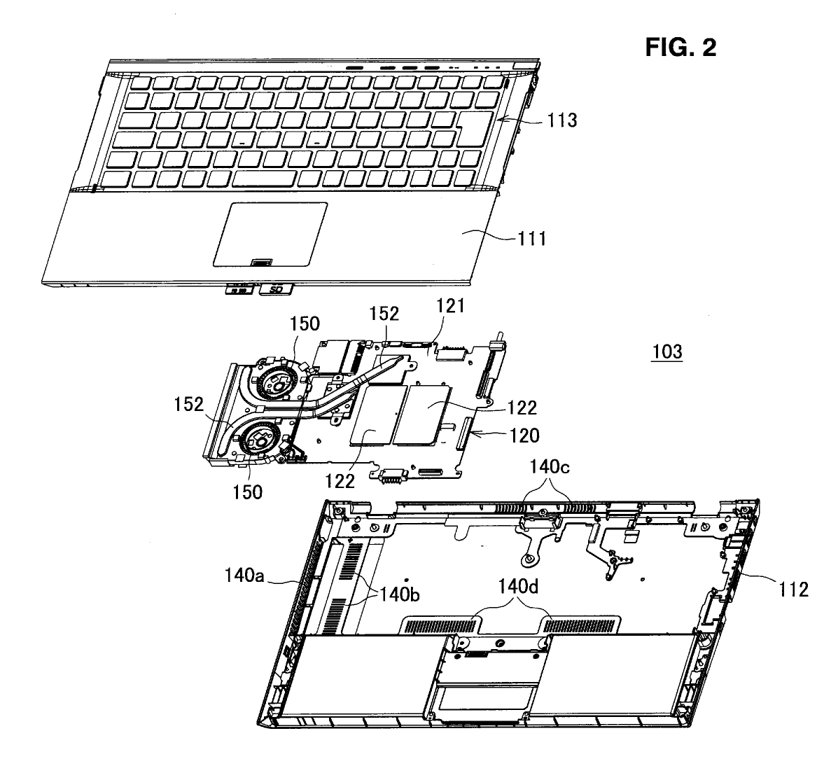

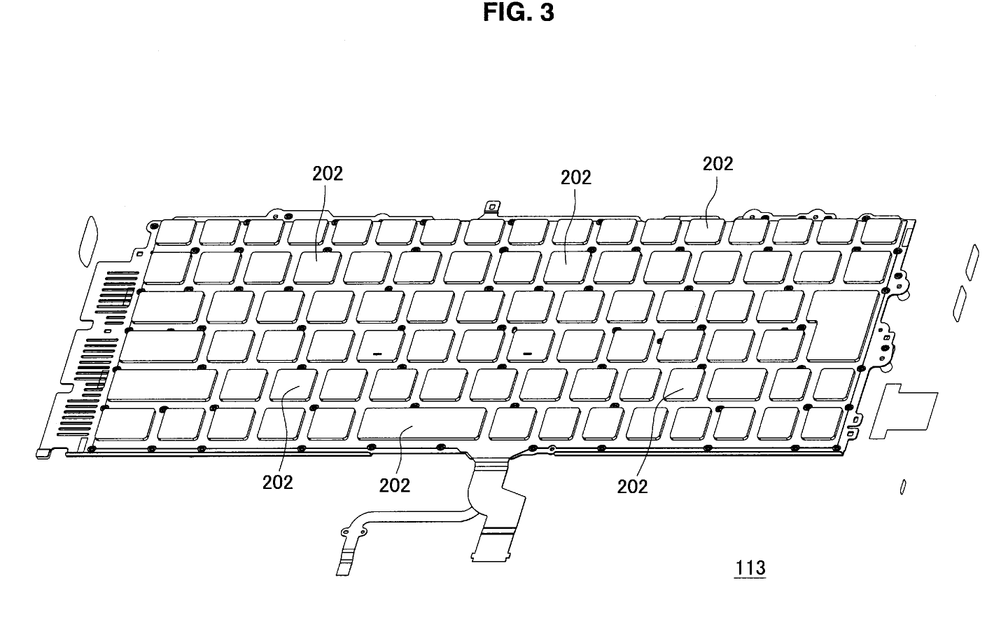

FIG. 2 is an exploded perspective view illustrating the apparatus main body 103. FIG. 3 is a perspective view illustrating the keyboard 113. The apparatus main body 103 has each unit provided on a main body housing 110 as necessary, and the main body housing 110 is made by coupling an upper shell 111 and a lower shell 112 in a vertical direction. As shown in FIG. 2, the keyboard 113 is mounted on the upper shell 111.

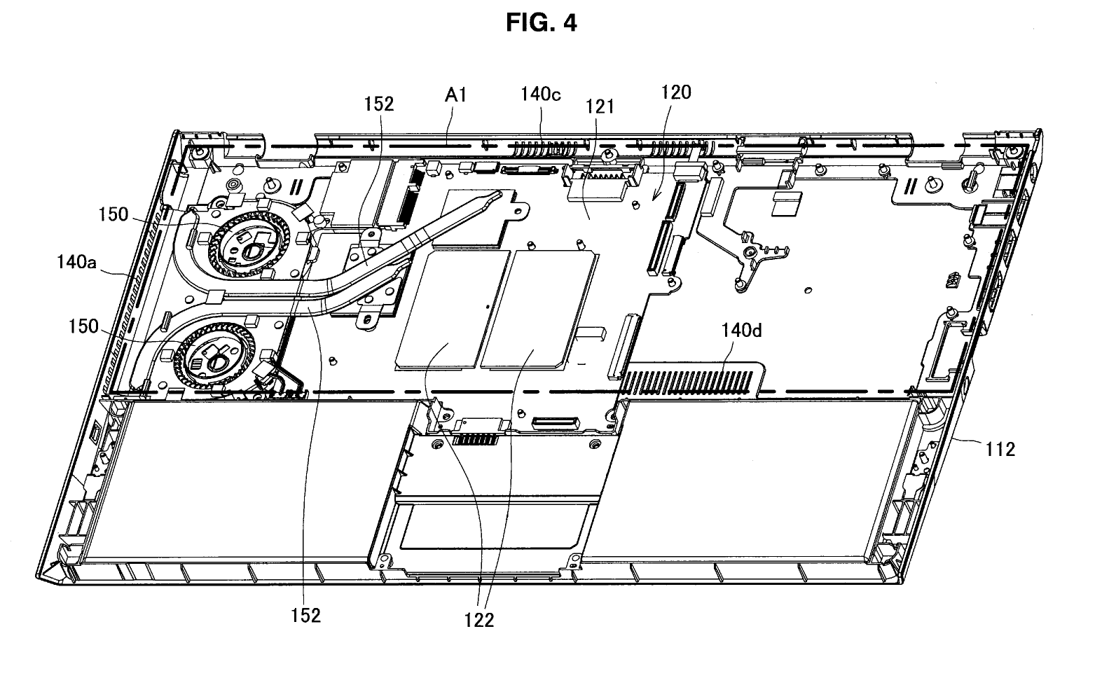

A circuit substrate assembly 120 is provided between the upper shell 111 and the lower shell 112. FIG. 4 illustrates the lower shell 112 to which the circuit substrate assembly 120 is attached. A region A1 enclosed by an alternate long and short dashed line in FIG. 4 corresponds to a region to which the keyboard 113 is attached. As shown in FIGS. 2 and 4, the circuit substrate assembly 120 includes a circuit substrate 121 on which electronic components 122 such as semiconductor chips are mounted. Examples of the electronic component 122 include a CPU, a hard disk, a DRAM, and a ROM.

A cooling fan 150 is provided adjacent to the circuit substrate 121. The cooling fan 150 has a function of drawing external air from the outside of the information processing apparatus 100 and discharging heat inside to the outside. The cooling fan 150 is constituted by a sirocco fan and the like, and discharges drawn air to a side (in a predetermined direction perpendicular to a rotational axis).

As shown in FIG. 2, a plurality of vent holes 140a, 140b, 140c, 140d are provided on the lower shell 112. The air in the main body housing 110 is discharged to the outside through the vent hole 140a of the plurality of vent holes 140a, 140b, 140c, 140d when the cooling fan 150 operates. External air is drawn into the inside of the main body housing 110 from the outside of the apparatus main body 103 through the vent holes 140b, 140c, 140d when the cooling fan 150 operates.

As described above, many electronic components 122 are provided on the circuit substrate 121 in the apparatus main body 103. The heat generated by these electronic components 122 is discharged to the outside of the apparatus main body 103 when external air is drawn through the vent holes 140b, 140c, 140d and is discharged through the vent hole 140a.

A heat pipe 152 is provided to connect the electronic components 122 and the cooling fan 150. The heat generated by the electronic components 122 is transmitted by the heat pipe 152 to the cooling fan 150, and the heat is discharged to the outside when the cooling fan 150 operates.

Moreover, in the present embodiment, external air is drawn into the apparatus main body 103 not only through the vent holes 140b, 140c, 140d but also through the entire keyboard 113 in order to further improve the cooling.

### [3. Configuration of Keyboard]

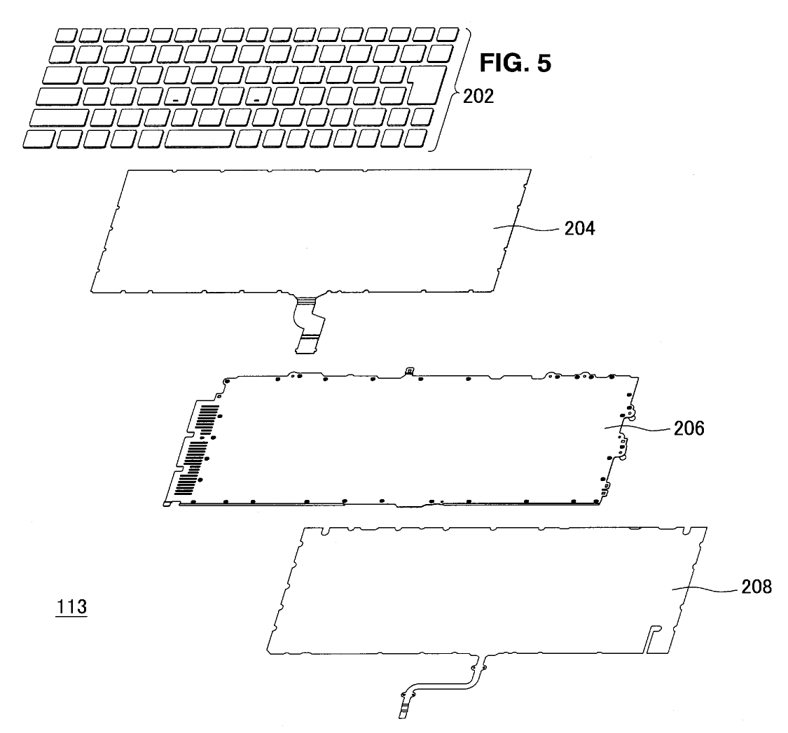

FIG. 5 is an exploded perspective view illustrating members constituting the keyboard 113. The keyboard 113 is configured to include a plurality of keys 202, a membrane sheet 204 provided below the keys 202, a plate (plate metal) 206 provided below the membrane sheet 204, and a light emitting sheet 208 provided below the plate 206.

Each key 202 is mounted on the plate 206 with the membrane sheet 204 interposed therebetween with a mechanical structure supporting the keys 202 so as to allow the keys to move in the vertical direction. The membrane sheet 204 has conductive wires for circuits corresponding to the respective keys 202. Press-down operation of the key 202 is transmitted to the membrane sheet 204. The membrane sheet 204 switches conduction/non-conduction of the conductive wire according to the press-down operation of the key 202, thus outputting a signal according to the key operation.

The plate 206 is provided at the lower portion of the membrane sheet 204, and has a support unit 206b holding the membrane sheet 204 from the lower side. Accordingly, when the membrane sheet 204 is pressed by the key 202 from above, the membrane sheet 204 can be supported from below.

The light emitting sheet 208 is provided below the plate 206, and is made of an organic EL light emitting sheet. The light emitting sheet 208 emits light to the keys 202 from below, thus functioning as a backlight for illuminating the characters of the keys 202. In the present embodiment, for example, the backlight is made of the organic EL light emitting sheet. However, the configuration of the backlight is not limited thereto. For example, the backlight may be made by causing a light source such as an LED to emit light onto a light guiding member on a flat plate and causing the light guiding member to emit light. In this case, an opening portion 208a described later can be provided on the light guiding member.

Although not shown in FIG. 5, the upper surface of the membrane sheet 204 is covered with an upper plate (decorative plate), i.e., an exterior member.

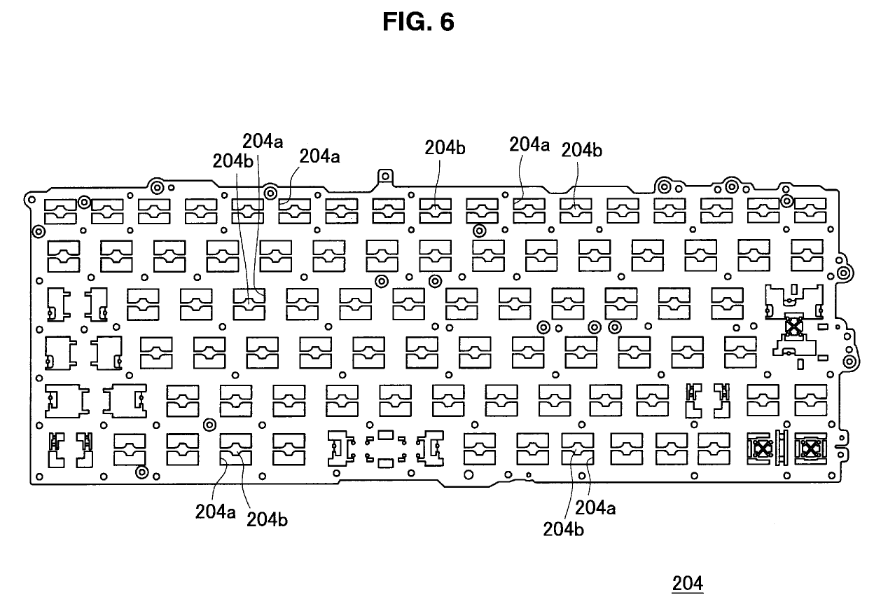

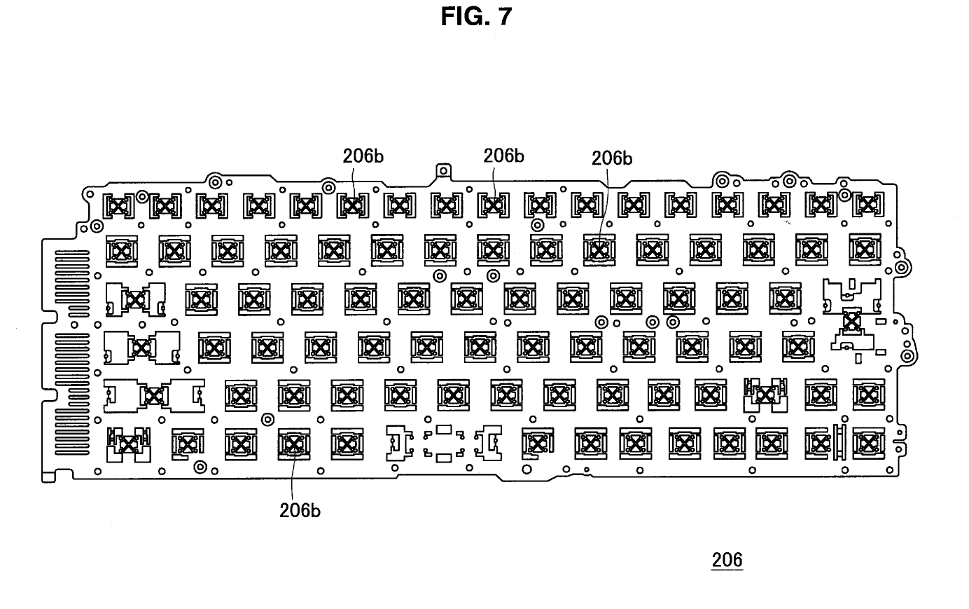

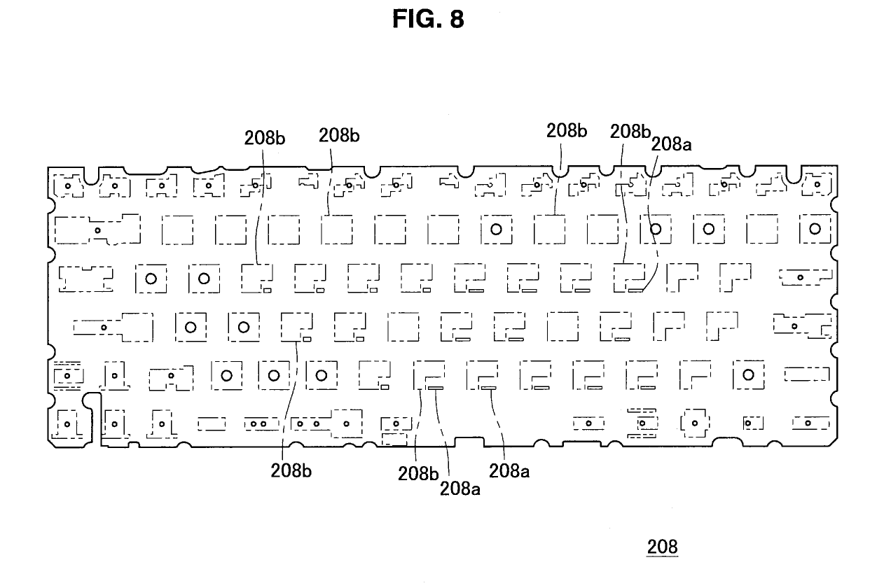

FIG. 6 is a top view illustrating a configuration of the membrane sheet 204. FIG. 7 is a top view illustrating a configuration of the plate 206. FIG. 8 is a top view illustrating a configuration of the light emitting sheet 208. As shown in FIG. 6, the membrane sheet 204 has switch units 204b each switching ON/OFF state of the conductive wire of the circuit corresponding to the position of each key 202. As shown in FIG. 7, the plate 206 has support units 206b each corresponding to the position of each switch unit 204b.

In FIG. 8, the regions enclosed by chain double-dashed lines denote light emitting units 208b of the light emitting sheet 208. Each light emitting unit 208b is provided to correspond to the position of each key 202. When the light emitting unit 208b emits light, the light is emitted to the key 202, so that the character on the key 202 illuminates. As shown in FIG. 8, the light emitting sheet 208 has opening portions 208a each penetrating through the light emitting sheet 208 at a position corresponding to the position of the key 202.

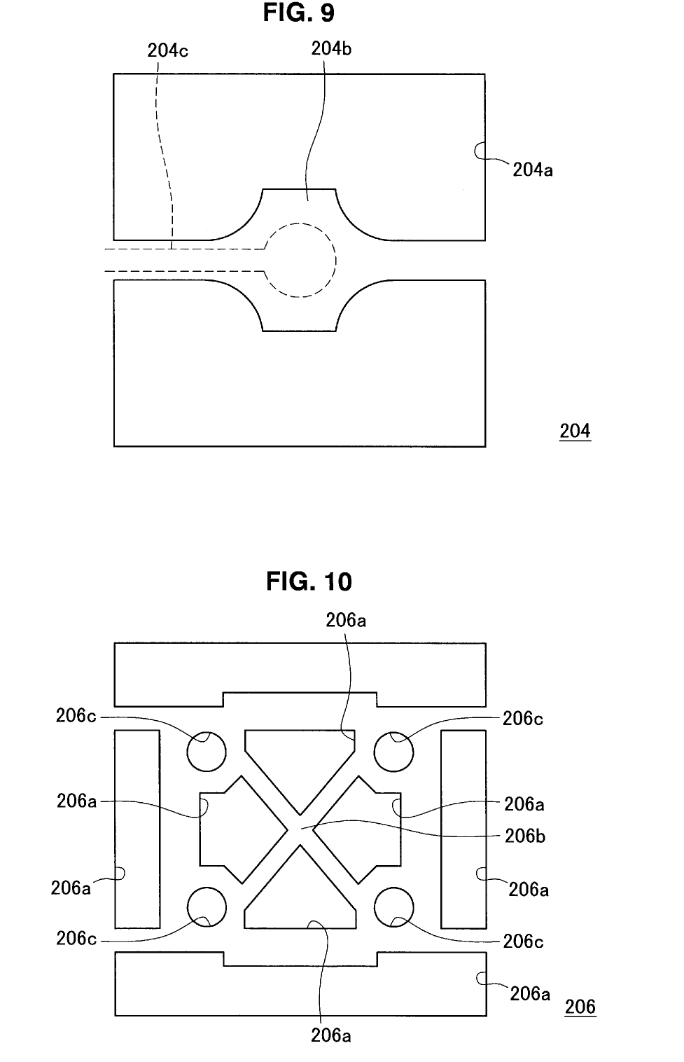

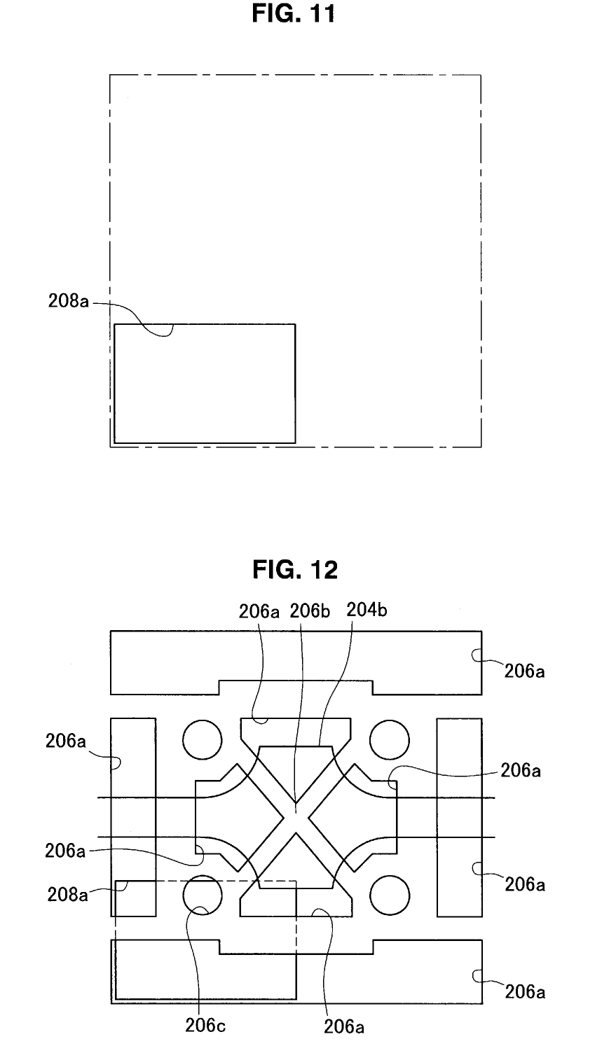

FIG. 9 is a top view illustrating the switch unit 204b of the membrane sheet 204 corresponding to the key 202. FIG. 10 is a top view illustrating the support unit 206b of the plate 206 corresponding to the key 202 and a periphery thereof. FIG. 11 is a top view illustrating the light emitting unit 208b and the opening portion 208a of the light emitting sheet 208 corresponding to the key 202. FIG. 12 is a top view illustrating the membrane sheet 204, the plate 206, and the light emitting sheet 208 shown in FIGS. 9, 10, and 11 when the membrane sheet 204, the plate 206, and the light emitting sheet 208 are overlaid.

As shown in FIG. 9, for example, the membrane sheet 204 is made by printing a conductive wire 204c on a semi-transparent resin material. As shown in FIG. 9, a penetrating opening portion 204a is provided around the switch unit 204b.

The support unit 206b of the plate 206 is formed in an X shape. A plurality of penetrating opening portions 206a are provided around the support unit 206b. As shown in FIG. 12, when the membrane sheet 204 and the plate 206 overlap each other, the switch unit 204b of the membrane sheet 204 is located at the center of the support unit 206b of the plate 206. With this configuration, when the switch unit 204b is pressed by the key 202 from above, the lower portion of the switch unit 204b can be supported by the support unit 206b.

On the plate 206, four key attachment holes 206c are provided for the key 202. A mechanical structure (not shown) for movably supporting each key 202 in a vertical direction is mounted on the key attachment holes 206c.

As shown in FIG. 12, the opening portion 208a of the light emitting sheet 208 is provided at a position overlapping the opening portion 204a of the membrane sheet 204 and the opening portion 206a of the plate 206. In this configuration, even when the membrane sheet 204, the plate 206, and the light emitting sheet 208 overlap each other, air can flow through the opening portions 204a, 206a, 208a.

As described above, the membrane sheet 204, the plate 206, and the light emitting sheet 208 are provided so that the opening portions 204a, 206a, 208a overlap the position corresponding to each key 202. Therefore, when the cooling fan 150 is driven, external air is drawn from clearances between the keys 202 and the upper plate, and the external air enters through the opening portions 204a, 206a, 208a into the inside of the apparatus main body 103. Then, the air is drawn in the direction of the cooling fan 150, and the air is discharged through the vent hole 140a.

Therefore, according to the present embodiment, the external air can be drawn through the opening portions 204a, 206a, 208a corresponding to the respective keys 202, and the air can be drawn from a wide range of the entire keyboard 113. Therefore, the cooling efficiency of the apparatus main body 103 can be greatly enhanced, and the electronic components 122 can be efficiently cooled.

### [4. Flow of Air Drawn Trough Keyboard]

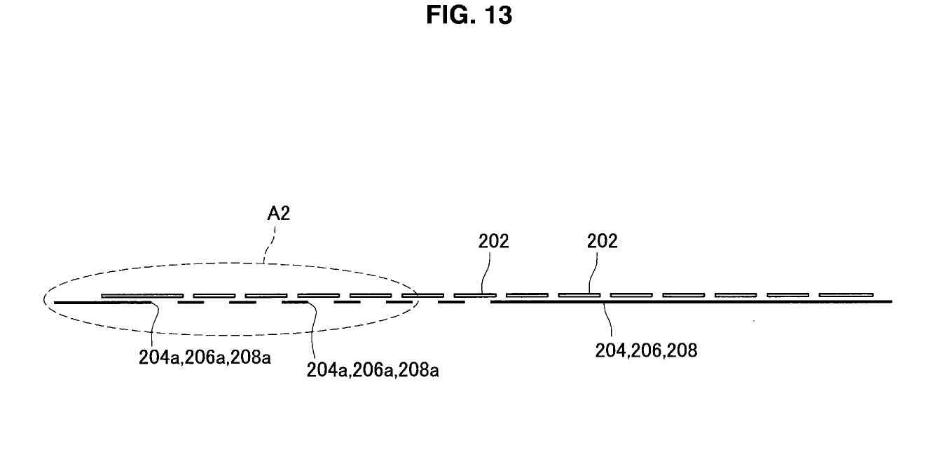

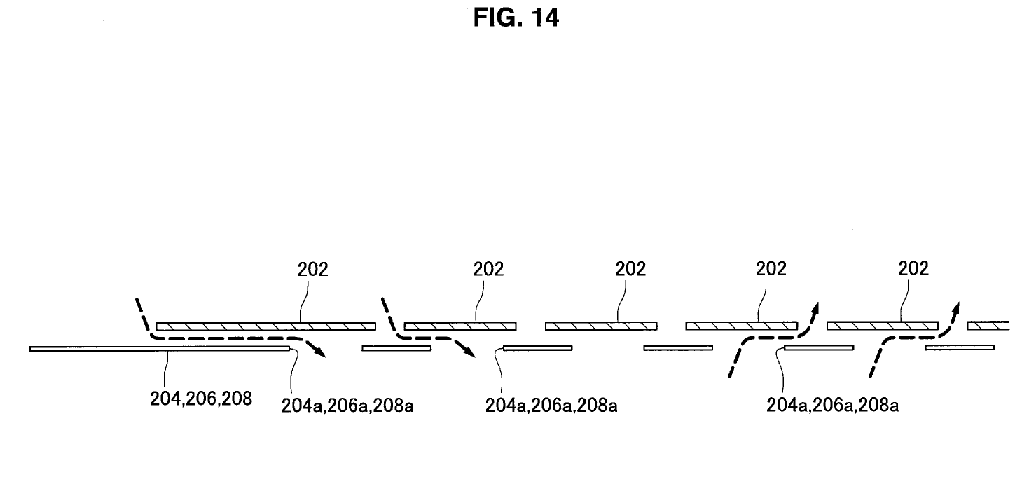

FIG. 13 is a schematic view illustrating a cross section of the keys 202 and the opening portions 204a, 206a, 208a. FIG. 14 is an enlarged schematic view illustrating a region A2 shown in FIG. 13, and shows how external air is drawn through the opening portions 204a, 206a, 208a when the cooling fan 150 is driven. As shown in FIG. 14, when the cooling fan 150 is driven, external air is drawn from clearances between the keys 202 and the upper plate on the membrane sheet 204, and the external air enters through the opening portions 204a, 206a, 208a into the inside of the apparatus main body 103. The opening portions 204a, 206a, 208a are provided to correspond to the keys 202. Therefore, the external air can be drawn into the inside of the apparatus main body 103 through the positions of the keys 202, i.e., the entire region of the keyboard 113.

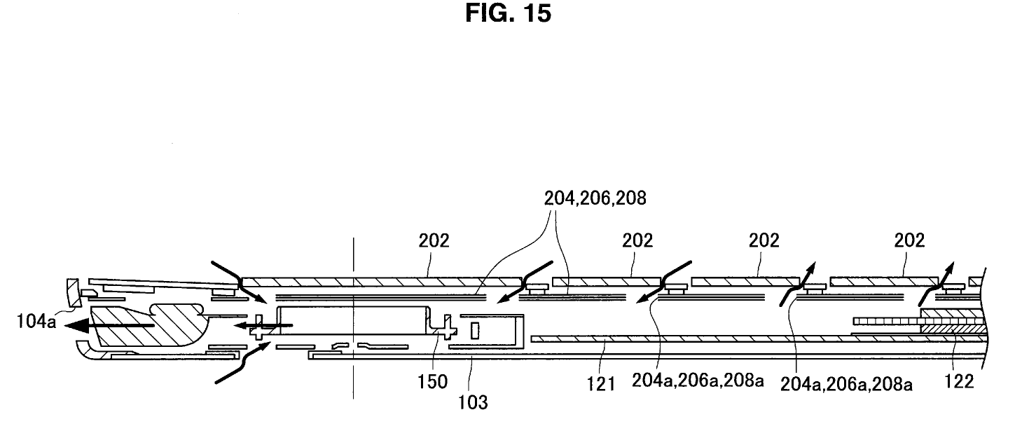

FIG. 15 is a schematic view illustrating a detailed cross sectional structure shown in FIG. 14, and shows both of the cooling fan 150 and the circuit substrate 121. As denoted by arrows in FIG. 15, the external air is drawn into the apparatus main body 103 through the opening portions 204a, 206a, 208a, and the external air flows in the direction of the cooling fan 150 in the apparatus main body 103. Then, the external air is discharged to the outside through the vent hole 140a. As a result, using the external air drawn through the opening portions 204a, 206a, 208a into the apparatus main body 103, the heat generated by the electronic components 122 can be discharged to the outside, and the inside of the apparatus main body 103 can be cooled efficiently.

As shown in FIG. 15, the opening portions 204a, 206a, 208a are not provided in the upper portion of the cooling fan 150, and this causes flow toward the cooling fan 150 in the apparatus main body 103, so that the cooling efficiency can be further enhanced.

### [5. Example of Arrangement of Opening Portion in Light Emitting Sheet]

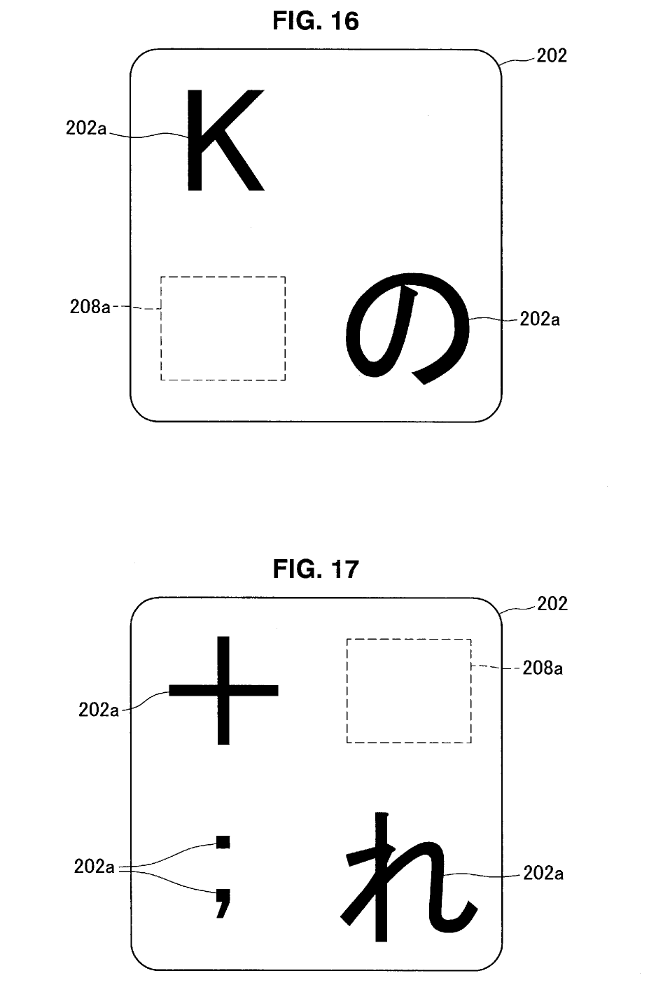

Subsequently, an example of arrangement of the opening portion 208a in the light emitting sheet 208 will be explained. FIG. 16 is a schematic view illustrating an example of positional relationship between the key 202 and the opening portion 208a. As shown in FIG. 16, a portion of the character (“K”, “NO (hiragana)”) of the key 202 is made as a light transmitting unit 202a which transmits light. The light transmitting unit 202a is made of a transparent or semi-transparent resin material. As a result, the light emitted by the light emitting unit 208b of the light emitting sheet 208 transmits through the light transmitting unit 202a, so that the portion of the character on the key 202 illuminates.

As shown in FIG. 16, the opening portion 208a of the light emitting sheet 208 is provided at a portion where the light transmitting unit 202a is not arranged. When the position of the opening portion 208a overlaps the position of the light transmitting unit 202a, the light emitting sheet 208 does not emit light in the opening portion 208a, which reduces the amount of light emitted to the light transmitting unit 202a, and the brightness of the light transmitting unit 202a is considered to decrease. As shown in the present embodiment, the opening portion 208a is provided in the portion where the light transmitting unit 202a is not arranged, so that this can reliably prevent reduction of the brightness of the light transmitting unit 202a.

FIG. 17 illustrates a key 202 with which more characters can be input and in which more light transmitting units 202a are provided. Even in this case, the opening portion 208a of the light emitting sheet 208 is provided in a region where the plurality of light transmitting units 202a are not arranged. This can reliably prevent reduction of the brightness of the light transmitting unit 202a.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-011417 filed in the Japan Patent Office on Jan. 21, 2011, the entire content of which is hereby incorporated by reference.

What is claimed is:

1. An information processing apparatus including a keyboard having a plurality of keys, the keyboard comprising:
a sheet having a plurality of switch units for switching a non-conductive state and a conductive state according to operation with which the plurality of keys are respectively pressed down, the sheet having a first opening portion at a position corresponding to at least one of the keys; and
a light emitting member provided below the sheet to emit light toward the key, the light emitting member having a second opening portion at a position corresponding to at least one of the keys.

2. The information processing apparatus according to claim 1,
wherein the key is engraved with a character with a light transmitting unit transmitting the light emitted by the light emitting member, and
the second opening portion is provided at a position not overlapping the character of the key.

3. The information processing apparatus according to claim 1, further comprising:
a plate provided between the sheet and the light emitting member to support the sheet and having a third opening portion at a position corresponding to the first opening portion.

4. The information processing apparatus according to claim 1, further comprising:
a cooling fan for discharging heat inside to outside,
wherein the second opening portion is provided in a region other than a portion immediately above the cooling fan.

5. An operation input device comprising:
a plurality of keys;
a sheet having a plurality of switch units for switching a non-conductive state and a conductive state according to operation with which the plurality of keys are respectively pressed down, the sheet having a first opening portion at a position corresponding to at least one of the keys; and
a light emitting member provided below the sheet to emit light toward the key, the light emitting member having a second opening portion at a position corresponding to at least one of the keys.

6. The operation input device according to claim 5,
wherein the key is engraved with a character with a light transmitting unit transmitting light emitted by the light emitting member, and
the second opening portion is provided at a position not overlapping the character of the key.

7. The operation input device according to claim 5, further comprising:
a plate provided between the sheet and the light emitting member to support the sheet and having a third opening portion at a position corresponding to the first opening portion.

8. The operation input device according to claim 5, further comprising:
a cooling fan for discharging heat inside to outside,
wherein the second opening portion is provided in a region other than a portion immediately above the cooling fan.
